(19) United States
(12) Patent Application Publication
(10) Pub. No.: US 2002/0108439 A1
(43) Pub. Date: Aug. 15, 2002

(54) Systems and methods for displaying status of consumable resource

(76) Inventor: Dennis D. Whitehead, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/788,627

(22) Filed: Feb. 14, 2001

(51) Int. Cl. G01F 23/00

(52) U.S. Cl. 73/290 V

(57) ABSTRACT

A system for displaying status of a consumable resource. In the illustrative application, the invention provides a system for determining a resource characteristic, e.g. a level of toner, in a cartridge without requiring use of a host machine. In a first embodiment, an alpha-numeric visual display or an audio device is provided on the cartridge. In alternative embodiments, data relating the characteristic is transmitted from the cartridge by a wireless transmitter. In one implementation, the transmitter is an infrared transmitter. In a second implementation, the transmitter is a Bluetooth enable transmitter. The wireless transmission is received by a compatible receiving device, preferably a hand held device, remotely located relative to the cartridge. An alpha-numeric and/or audio device is provided at the receiver for outputting information relating to the resource. An indicator is also provided on the cartridge to signal which cartridge is transmitting data at any given time.

### BACKGROUND OF THE INVENTION

1. Field of Invention

This invention relates to printers, copiers, facsimile machines and other systems which use consumable resources such as ink or toner. Specifically, the present invention relates to systems and methods for monitoring such consumable resources.

2. Description of the Related Art

Printers, copiers, facsimile machines and numerous other devices use consumable resources such as ink or toner. The toner is typically provided in a cartridge. While inexpensive devices may use simple cartridges, cartridges used in laser printers are typically considerably more sophisticated. In any event, there has been a need in the art for systems and methods for monitoring resource levels in machines that use consumable resources.

Currently, several methods are known in the art for monitoring consumable resources, particularly toner levels. The most widely used method is to simply examine the quality of the output of the machine. As toner levels become low, the print or copy quality typically drops dramatically. Unfortunately, there is a need to be able to detect a low toner condition prior to the appearance of poor print quality. This is particularly important in high speed machines as a large number of documents may be output before the low toner condition is detected.

In some cases, a visual indicator such as a window has been provided on the cartridge. However, this manual system requires an operator to open the machine and inspect the toner cartridge on some regular interval.

Accordingly, a need has been recognized for an automatic system for detecting cartridge levels. One such automated system uses electro-optic techniques. These techniques, used more often for the more complex laser printer/copier cartridge, have employed an optical sensor in a passive system or an active system, employing a light source, to examine toner level. U.S. Pat. No. 5,943,525, issued Aug. 24, 1999 to Endo et al and entitled TONER REMAINING DETECTION UNIT IN AN IMAGE FORMING APPARATUS, the general teachings of which are incorporated herein by reference, purports to disclose a toner remaining detection unit that displays the amount of remaining toner according to the number of transitions from a low state to a full state.

Another approach involves the use of a rod disposed in a lower section of the supply hopper of the cartridge that acts as an antenna. An associated electrical circuit senses a change in the ambient electromagnetic field due to lower toner levels.

Still another approach involves the use of conductive plates in the supply hopper. When a voltage is applied to the plates, changes in capacitance between the plates due to lower toner level may be detected by a sensing circuit.

Unfortunately, there are numerous shortcomings associated with these automated approaches. First, these approaches generally require the use of the printer or copier in which the toner cartridge is used. This is problematic in those applications in which it is desirable to ascertain toner levels in cartridges that are not installed. One such application arises when used cartridges are stored. In this case, one might want to know how much toner is in the cartridge without having to actually install the cartridge in the printer or copier. Another application arises in the examination of cartridges to the manufacturer or supplier for warranty service, as some warranties may be based on cartridge usage.

Hence, a need remains in the art for a system or method for ascertaining remaining consumable resource level, particularly with respect to toner in cartridges, without the necessity of installing the cartridge in a printer, copier or other apparatus.

### SUMMARY OF THE INVENTION

The need in the art is addressed by the system for displaying status of a consumable resource of the present invention. In the illustrative application, the invention provides a system for determining a resource characteristic, e.g. a level of toner, in a cartridge without requiring use of a host machine. In a first embodiment, an alpha-numeric visual display or an audio device is provided on the cartridge. In alternative embodiments, data relating the characteristic is transmitted from the cartridge by a wireless transmitter. In one implementation, the transmitter is an infrared transmitter. In a second implementation, the transmitter is a Bluetooth enable transmitter. The wireless transmission is received by a compatible receiving device, preferably a hand held device, remotely located relative to the cartridge. An alphanumeric and/or audio device is provided at the receiver for outputting information relating to the resource. An indicator is also provided on the cartridge to signal which cartridge is transmitting data at any given time.

### BRIEF DESCRIPTION OF THE DRAWINGS

FIG. 1 is a perspective view of a laser toner cartridge implemented with the system and method for displaying a status of a consumable resource of the present invention.

FIG. 2 is a simplified view of a laser printer with a schematic side view of the cartridge along with a block diagram of the system for displaying status of a consumable resource of the present invention.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

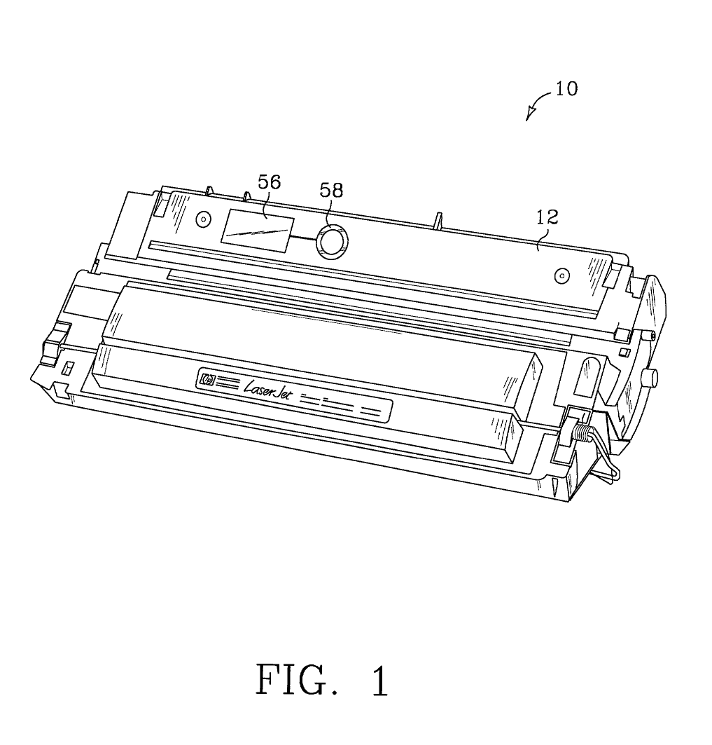

FIG. 1 is a perspective view of a laser toner cartridge implemented with the system and method for displaying a status of a consumable resource of the present invention. As illustrated in FIG. 1, the cartridge 12 includes a microchip controller 42 (not shown) on which a touch screen 56 is mounted. Also shown in FIG. 1 is an optional speaker 58 connected to the microchip controller 42.

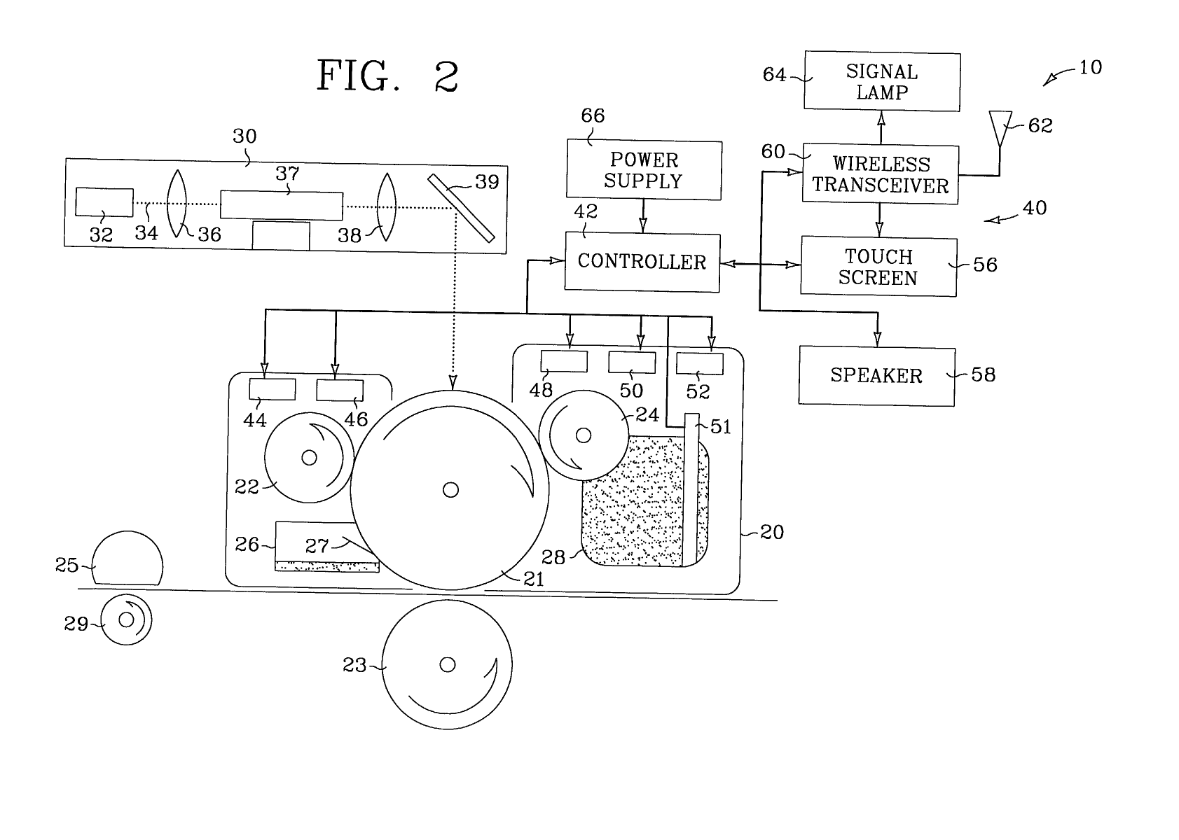

FIG. 2 is a simplified view of a laser printer with a schematic side view of the cartridge along with a block diagram of the system for displaying status of a consumable resource of the present invention. The system 10 includes a cartridge 20 adapted for use with a laser scanner 30. As is common in the art, the scanner 30 includes a laser 32 which outputs a scanning beam 34. The beam is focused by a first lens 36 and input to a rotating mirror 37. A second lens 38 further focuses the beam 34. A scanning mirror 39 directs the beam to a photosensitive drum 21 in the cartridge 20. Along with the drum 21, the cartridge 20 includes a charge roller 22, a developing roller 24, a cleaning station (including a debris cavity 26 and a rubber cleaning blade 27) and a toner cavity 28. External to the cartridge, the laser printer typically includes a transfer roller 23, a fuser 25 and a lower fuser roller (fuser pressure roller) 29.

As is well-known in the art, printing on a laser printer requires the interaction of several different technologies (electronics, optics, electro-photographics, etc.) to provide a page of printed output. Each process functions independently and must be coordinated with other printer processes. The image formation process centers around the photosensitive drum and consists of six stages: cleaning, conditioning, writing, developing, transferring, and fusing. The photosensitive drum 21 is the heart of the image formation system. The special properties of the drum allow the image to be formed on the drum surface and then be transferred to paper. The drum 21 is preferably an extruded aluminum cylinder. The outside of the cylinder is coated with a layer of organic-photoconductive material (OPC) not shown. The aluminum base of the drum is electrically connected to ground. The OPC material has properties similar to a photodiode. It becomes electrically conductive (in one direction only) when exposed to light. Negative charges deposited on the surface of the drum conduct to the aluminum base of the drum when exposed to light. The aluminum base of the drum is at zero potential. Areas of the drum not exposed to light remain nonconductive.

During the cleaning stage of the image formation process, the drum's surface is prepared to hold an image by physically and electrostatically cleaning the drum. During printing, the drum is constantly rotating and makes several complete rotations per printed page. Before forming the image for a given section of print, leftover toner from the previous rotation of the drum must be cleaned off. This is accomplished by the cleaning blade 27 which scrapes toner off the drum into a debris cavity. The sweeper blade in the debris cavity is in low force contact with the OPC, preventing debris from exiting the debris hopper.

After the drum 21 is physically cleaned, the drum must be conditioned. The conditioning process typically consists of the application of a uniform negative charge on the surface of the drum by a charge roller. The exterior surface of the charge roller is negatively charged and transfers a uniform negative charge to the surface of the OPC drum. This transfer of charge also neutralizes electrical charges which may have previously been on the drum.

After rotating past the conditioning station, the drum has a uniform negative potential on its surface (e.g. 600 volts). At the writing station, the laser beam 34 is used to discharge this potential in selected areas by focusing laser light on the selected portions of the photo-conductive drum. This creates what is known as an ‘electrostatic or latent image’. The beam 34 is swept by the rotating mirror 37 across the length of the drum. Rotation of the drum 21 allows for the entire circumference to be accessed by the beam. The machine control system turns the beam on and off by turning the laser 32 on and off. The sweeping of the drum and modulation of the beam leave an invisible electrostatic latent image on the portions of the drum that were not exposed to the laser that are still at the negative potential (−600 V) placed there by the primary charge roller and those portions exposed to the light that have been discharged to approximately −100 volts.

At the developing station, the invisible electrostatic image is developed into a visible image on the drum. The developer consists of a metallic rotating cylinder (developing roller 24), a fixed magnet that runs the length of the roller (not shown), and the toner cavity 28. The toner in the cavity is a powdery substance, typically made of black plastic resin bound to iron particles. The iron in the toner causes an attraction of the toner to the magnet inside the cylinder. A brush height control blade (not shown) limits the amount of toner on the roller 24 as it rotates. The plastic toner particles obtain a negative surface charge by rubbing against the cylinder which is connected to a negative direct current (DC) supply. This electrostatic charge, obtained by the toner, is such that the toner particles are attracted to the areas of the drum which have been exposed to laser light and repelled from the areas not exposed. An alternating current (AC) potential is also applied to the developing roller 24 in order to further assist the toner particles to overcome the attraction of the magnet and to pull toner back to the cylinder from areas on the drum that were not exposed.

At a transfer station, the toner image on the drum is transferred to the paper. A corona assembly (not shown) is positioned behind the paper, so that the paper, which is traveling at the same speed that the surface of the drum is rotating, contacts the drum. This corona produces positive charges which deposit on the back of the paper. The stronger positive charges on the paper pull the negatively charged toner particles off the drum. From the transfer station, the paper moves to the fusing station and the drum rotates to the cleaning station to prepare it to receive the next section of print.

Clearly, the printing of multiple sheets of paper depletes the supply of toner. As mentioned above, several techniques are known in the art for monitoring toner levels. However, no techniques are known in the art for providing an indication of the level or amount of toner in the cavity 28 which is operative without the cartridge 20 being installed in a printer, copier or other machine.

In accordance with the present teachings, a toner level sensor 51 is provided in the cavity 28 and the output of same is input to a controller 42 in a monitoring circuit 40. In the illustrative embodiment, the controller compares the detected toner level to a stored threshold and outputs data to a touch screen 56 and to an optional speaker 58 for audio output. User input may be received via the touch screen 56. As an alternative, the controller 42 may output a signal to a remote receiver via a wireless transceiver 60. In the best mode, the wireless transceiver 60 is a Bluetooth enable transceiver operative through an antenna 62. Those skilled in the art will appreciate that the transceiver may be an infrared transceiver without departing from the scope of the present teachings. A signal lamp 64 is provided to provide an external indication of the activation of the transceiver 60. The circuit 40 is powered by a supply 66, which may be a battery, solar cell or other suitable device.

In accordance with the present teachings, the circuit 40 is mounted on or in the cartridge as depicted in FIG. 1 and is clearly independent of the printer, copier or other host machine. The circuit 40 is adapted to accept input from a plurality of additional sensors and to provide output with respect thereto as well. As shown in FIG. 2, sensors 44, 46, 48, 50 and 52 are included to detect current or voltage on the charge roller 22, speed of the drum 21, current or voltage on the developing roller 24, shock or vibration and temperature or humidity, respectively.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A system for displaying a level of a resource comprising:
a container adapted to retain a resource;
means disposed at said container for sensing a characteristic of said resource and
means mounted on said container and coupled to said means for sensing for providing an indicator of said characteristic, said means for providing an indicator including electronic means for providing an indication of said characteristic.

2. The invention of claim 1 wherein said container is a cartridge.

3. The invention of claim 2 wherein said resource is toner.

4. The invention of claim 1 wherein said means for providing an indicator includes a visual display.

5. The invention of claim 4 wherein said display is an alpha-numeric display.

6. The invention of claim 5 wherein said display is a liquid crystal display.

7. The invention of claim 1 wherein said means for providing an indicator includes an audio device.

8. A system for displaying a level of a resource comprising:
a container adapted to retain a resource;
means disposed at said container for sensing a characteristic of said resource; and
a wireless transmitter coupled to said means for sensing for transmitting data relating to said characteristic.

9. The invention of claim 8 further including means mounted remotely with respect to said container for receiving said data.

10. The invention of claim 9 further including means disposed remotely with respect to said container and coupled to said means for receiving for displaying said data.

11. The invention of claim 8 wherein said container is a cartridge.

12. The invention of claim 11 wherein said resource is toner.

13. The invention of claim 8 wherein said means for transmitting includes an infrared transmitter.

14. The invention of claim 8 wherein said means for transmitting includes a wireless electromagnetic transmitter.

15. The invention of claim 14 wherein said transmitter is a Bluetooth transmitter.

16. The invention of claim 8 wherein said means for receiving includes an audio device.

17. A system for displaying a level of a resource comprising:
a container adapted to retain a resource;
means disposed at said container for sensing a characteristic of said resource;
a wireless transmitter coupled to said means for sensing for transmitting data relating to said characteristic; and
means disposed on said container for providing a visual indication of an activation of said transmitter.

18. The invention of claim 17 further including means mounted remotely with respect to said container for receiving said data.

19. The invention of claim 18 further including means disposed remotely with respect to said container and coupled to said means for receiving for displaying said data.

20. A system for displaying a level of a resource comprising:
a container adapted to retain a resource;
means disposed at said container for sensing a characteristic of said resource;
a wireless transmitter coupled to said means for sensing for transmitting data relating to said characteristic; and
means disposed on said container for providing a visual indication of a characteristic of said resource.

21. The invention of claim 20 further including means mounted remotely with respect to said container for receiving said data.

22. The invention of claim 21 further including means disposed remotely with respect to said container and coupled to said means for receiving for displaying said data.
